(19) United States
(12) Patent Application Publication
(10) Pub. No.: US 2026/0274222 A1
(43) Pub. Date: Sep. 17, 2026

(54) BRAKING CONTROL DEVICE

(71) Applicant: ADVICS CO., LTD., Kariya-shi, Aichi-ken (JP)

(72) Inventor: Yusaku YAMAMOTO, Kariya-shi, Aichi-ken (JP)

(73) Assignee: ADVICS CO., LTD., Kariya-shi, Aichi-ken (JP)

(21) Appl. No.: 19/167,574

(22) PCT Filed: Mar. 22, 2024
(86) PCT No.: PCT/JP2024/011424

§ 371 Date: Sep. 22, 2025

(30) Foreign Application Priority Data
Mar. 23, 2023 (JP) 2023-046227

(51) Int. Cl. B60T 8/1755; B60T 8/171; B60T 8/24; B60T 8/58

(52) U.S. Cl. CPC B60T 8/17551; B60T 8/171; B60T 8/245; B60T 8/58; B60T 2210/20; B60T 2220/04; B60T 2230/04; B60T 2240/00; B60T 2250/04

(57) ABSTRACT

When operating a braking operation member to stop a vehicle, a processing circuit of a braking control device executes a reduction correction control for applying an instruction braking force that is smaller than a required braking force to the vehicle to prevent an attitude change of the vehicle accompanying the stopping. The processing circuit functions as: an operation amount increase determination unit configured to determine whether the operation amount is increasing while the reduction correction control is being executed; and an instruction value increase unit configured to, when the operation amount increase determination unit determines that the operation amount is increasing, increase the instruction braking force so that a difference between the instruction braking force and the required braking force decreases.

### TECHNICAL FIELD

The disclosure here relates to a braking control device that controls a braking force applied to a vehicle.

### BACKGROUND ART

PTL 1 discloses a control device that executes a braking control for preventing a change in a vehicle attitude during stopping of the vehicle by using a regenerative braking force generated by a motor generator and a friction braking force generated by a hydraulic actuator. When a vehicle speed becomes equal to or lower than a predetermined speed, the control device controls the motor generator to reduce the regenerative braking force toward 0 (zero). When the vehicle speed becomes (0) zero, the control device operates the hydraulic actuator to increase the friction braking force. Accordingly, the control device can maintain the vehicle in a stopped state while preventing a sudden change in the attitude of the vehicle during the stopping of the vehicle.

### CITATION LIST

### Patent Literature

PTL 1: JP2016-28913A

### SUMMARY

### Technical Problem

The driver may increase an operation amount of a brake pedal while the braking control is being executed for reducing the braking force for the purpose of preventing a sudden change in the attitude of the vehicle during the stopping of the vehicle. That is, while the braking control is being executed, there is a concern that the operation on the brake pedal executed by the driver and the braking control may counteract each other.

### Solution to Problem

A braking control device for solving the above problem is a device for executing, when a driver of a vehicle is operating a braking operation member of the vehicle to stop the vehicle while the vehicle is traveling, a reduction correction control for applying, to the vehicle, an instruction braking force smaller than a required braking force that is a braking force corresponding to an operation amount of the braking operation member by the driver, in order to prevent an attitude change of the vehicle accompanying the stopping. the braking control device includes: an operation amount increase determination unit configured to determine whether the operation amount is increasing while the reduction correction control is being executed; and an instruction value increase unit configured to, when the operation amount increase determination unit determines that the operation amount is increasing, increase the instruction braking force such that a difference between the instruction braking force and the required braking force decreases.

### Advantageous Effects

The braking control device has an effect of capable of causing the vehicle to generate a deceleration according to an intention of the driver when the driver increases the operation amount of the braking operation member while the reduction correction control is being executed.

### BRIEF DESCRIPTION OF DRAWINGS

FIG. 1 is a configuration diagram schematically illustrating a vehicle including a braking control device according to a first embodiment.

FIGS. 2A to 2C are timing charts illustrating transitions in a braking force and a remaining travel distance when a braking control during stopping is executed.

FIG. 3 is a flowchart illustrating a flow of a series of processing executed by a processing circuit included in the braking control device illustrated in FIG. 1.

FIGS. 4A and 4B are timing charts in a case in which an operation amount of a braking operation member is changed while an increase correction control of the braking control during stopping is being executed.

FIG. 5 is a flowchart illustrating reduction processing in the series of processing illustrated in FIG. 3.

FIGS. 6A and 6B are timing charts in a case in which the operation amount of the braking operation member is reduced while a reduction correction control is being executed.

FIGS. 7A to 7C are timing charts in a case in which the operation amount of the braking operation member is increased or reduced while the reduction correction control is being executed.

FIG. 8 is a flowchart illustrating a part of a series of processing executed by a processing circuit included in a braking control device according to a second embodiment.

FIG. 9 is a block diagram illustrating a functional configuration of a braking control device according to a modification.

### DESCRIPTION OF EMBODIMENTS

### First Embodiment

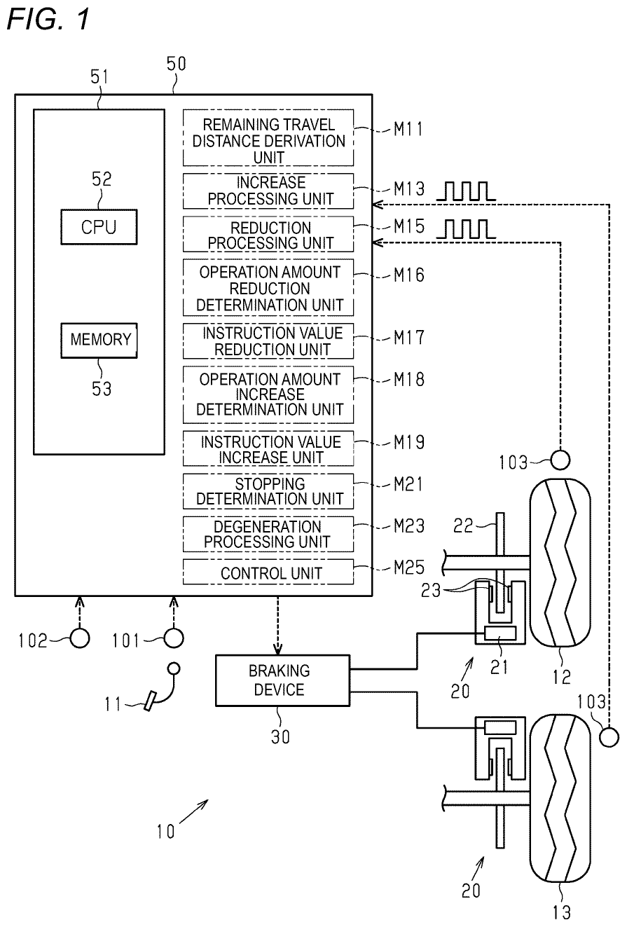

Hereinafter, a first embodiment of a braking control device will be described with reference to FIGS. 1 to 7C.

FIG. 1 illustrates a vehicle 10 including a braking control device 50. The vehicle 10 includes a braking operation member 11, a plurality of wheels, a plurality of friction brakes 20, and a braking device 30. The braking operation member 11 is a member operated by a driver when applying a braking force to the vehicle 10. For example, the braking operation member 11 is a brake pedal or a brake lever. The plurality of wheels include two front wheels 12 and two rear wheels 13.

### <Friction Brake>

The plurality of friction brakes 20 apply braking forces to the corresponding wheels. The friction brake 20 includes a wheel cylinder 21, a rotation body 22, and a friction portion 23. Since the rotation body 22 rotates integrally with the wheel, a braking force is applied to the wheel by pressing the friction portion 23 against the rotation body 22. The force pressing the friction portion 23 against the rotation body 22 increases as a wheel hydraulic pressure, which is a hydraulic pressure in the wheel cylinder 21, increases. Therefore, the friction brake 20 can apply a larger braking force to the wheel as the wheel hydraulic pressure increases.

### <Braking Device>

The braking device 30 controls the braking force applied to the wheels 12 and 13 by controlling the wheel hydraulic pressure of the plurality of wheel cylinders 21. For example, the braking device 30 includes a pressurizing source that supplies a brake fluid to the plurality of wheel cylinders 21. The pressurizing source is, for example, an electric pump and an electric cylinder. The braking device 30 can individually adjust the wheel hydraulic pressure of the wheel cylinder 21 for the front wheel 12 and the wheel hydraulic pressure of the wheel cylinder 21 for the rear wheel 13.

In the following description, the total of the braking forces applied to the plurality of wheels 12 and 13 is also referred to as a “braking force BPAl applied to the vehicle 10”.

### <Detection System>

A detection signal is input to the braking control device 50 from a detection system. The detection system includes a plurality of sensors. The plurality of sensors include a brake sensor 101, a longitudinal acceleration sensor 102, and a plurality of wheel speed sensors 103.

The brake sensor 101 detects information related to the operation on the braking operation member 11 executed by the driver. An example of the brake sensor 101 is a stroke sensor that detects an operation amount of the braking operation member 11 implemented by the driver. The detection system may include a sensor that detects an operation force of the braking operation member 11 implemented by the driver.

The longitudinal acceleration sensor 102 detects a longitudinal acceleration of the vehicle 10 among accelerations acting on the vehicle 10. The longitudinal acceleration of the vehicle 10 based on the detection signal of the longitudinal acceleration sensor 102 is referred to as a “longitudinal acceleration Gx”. When a gradient of a traveling road of the vehicle 10 changes, an output value corresponding to the detection signal of the longitudinal acceleration sensor 102 changes. That is, the longitudinal acceleration sensor 102 corresponds to a “gradient detection sensor” that detects a road surface gradient.

The wheel speed sensor 103 is provided for each of the plurality of wheels. Each of the plurality of wheel speed sensors 103 detects a rotation speed of the corresponding wheel. The wheel speed sensor 103 outputs a pulse signal according to the rotation speed of the wheel. A generation cycle of the pulse included in the pulse signal is a cycle corresponding to the rotation speed of the wheel. Specifically, the wheel speed sensor 103 outputs, as a detection signal, a pulse signal whose pulse generation cycle becomes shorter as the rotation speed of the wheel becomes higher. The rotation speed of the wheel based on the detection signal is referred to as a “wheel speed VW”.

### <Braking Control Device>

The braking control device 50 includes a processing circuit 51. For example, the processing circuit 51 is an electronic control device. In this case, the processing circuit 51 includes a CPU 52 and a memory 53. The memory 53 stores a control program to be executed by the CPU 52. When the CPU 52 executes the control program, the processing circuit 51 controls the braking device 30 to operate the plurality of friction brakes 20. That is, the processing circuit 51 can adjust the braking force BPAl applied to the vehicle 10 by operating the plurality of friction brakes 20.

<braking Control During Stopping>

The processing circuit 51 executes a braking control during stopping when the driver is operating the braking operation member 11. The braking control during stopping is a braking control for preventing a sudden attitude change of the vehicle 10 accompanying the stopping by adjusting a braking force applied to the vehicle 10 when the vehicle 10 is being stopped by braking.

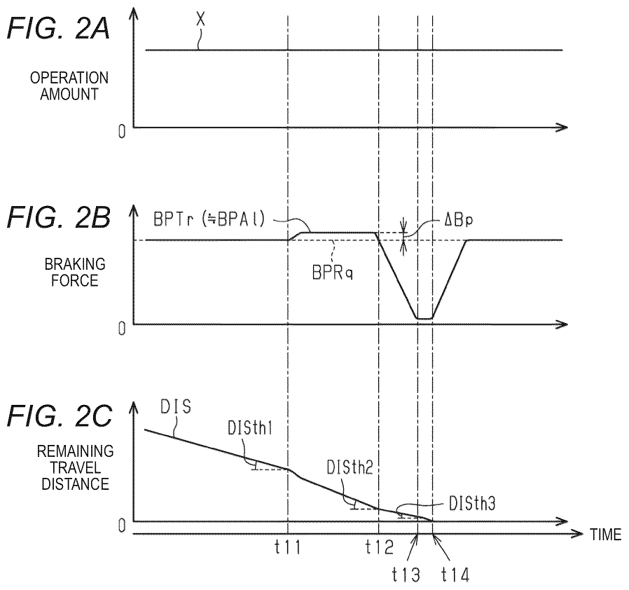

The braking control during stopping executed by the braking control device 50 will be described with reference to FIGS. 2A to 2C.

When the driver is operating the braking operation member 11 as illustrated in FIG. 2A, the processing circuit 51 derives a required braking force BPRq such that a value increases as an operation amount X of the braking operation member 11 increases. As illustrated in FIG. 2C, the processing circuit 51 derives a remaining travel distance DIS of the vehicle 10 during braking of the vehicle 10. The remaining travel distance DIS is a distance over which the vehicle 10 travels until the vehicle 10 stops. When the remaining travel distance DIS is longer than a first travel distance determination value DISth1 as before a timing t11, the processing circuit 51 sets the required braking force BPRq as an instruction braking force BPTr. Then, as illustrated in FIG. 2B, the processing circuit 51 operates the braking device 30 such that the braking force BPAl applied to the vehicle 10 becomes the instruction braking force BPTr.

At the timing t11, the remaining travel distance DIS becomes the first travel distance determination value DISth1. Therefore, the processing circuit 51 starts the braking control during stopping. From the timing t11, the processing circuit 51 starts increase processing of the braking control during stopping. In the increase processing, the processing circuit 51 sets a braking force larger than the required braking force BPRq as the instruction braking force BPTr. For example, the processing circuit 51 sets the sum of the required braking force BPRq and an offset value ΔBP as the instruction braking force BPTr. Then, the processing circuit 51 operates the braking device 30 such that the braking force BPAl applied to the vehicle 10 becomes the instruction braking force BPTr. Accordingly, even when the required braking force BPRq is the same, the deceleration of the vehicle 10 becomes larger than that before the timing t11 by the offset value ΔBP. The control of applying the instruction braking force BPTr set in the increase processing to the vehicle 10 is also referred to as an “increase correction control”.

At a timing t12, the remaining travel distance DIS becomes a second travel distance determination value DISth2. A distance shorter than the first travel distance determination value DISth1 is set as the second travel distance determination value DISth2. When the remaining travel distance DIS is equal to or less than the second travel distance determination value DISth2, it can be considered that the vehicle 10 has approached a predicted stopping position. Therefore, the processing circuit 51 shifts the processing for setting the instruction braking force BPTr from the increase processing to reduction processing. In the reduction processing, the processing circuit 51 reduces the instruction braking force BPTr at a constant speed. Then, the processing circuit 51 operates the braking device 30 such that the braking force BPAl applied to the vehicle 10 becomes the instruction braking force BPTr. Accordingly, even when the required braking force BPRq is the same, the deceleration of the vehicle 10 gradually decreases. The control of applying the instruction braking force BPTr set in the reduction processing to the vehicle 10 is also referred to as a “reduction correction control”. That is, the reduction correction control is a control for applying the instruction braking force BPTr smaller than the required braking force BPRq to the vehicle 10.

At a timing t13, the instruction braking force BPTr becomes equal to a gradient corresponding braking force BPθ. Then, in the reduction processing, the processing circuit 51 holds the instruction braking force BPTr at the gradient corresponding braking force BPθ. A braking force corresponding to a road surface gradient θ at the timing t11 at which the increase processing is started is set as the gradient corresponding braking force BPθ. Therefore, if the road surface gradient θ does not change from the timing t11, by setting the braking force BPAl to be equal to or greater than the gradient corresponding braking force BPθ, the vehicle 10 can be stopped, and the vehicle 10 can be maintained stopped thereafter.

At a timing t14, since the processing circuit 51 determines that the vehicle 10 has stopped, the processing circuit 51 shifts the processing for setting the instruction braking force BPTr from the reduction processing to degeneration processing. In the degeneration processing, the processing circuit 51 increases the instruction braking force BPTr. For example, the processing circuit 51 increases the instruction braking force BPTr to the required braking force BPRq. The braking force BPAl applied to the vehicle 10 is increased by the processing circuit 51 operating the braking device 30 based on the instruction braking force BPTr. The control of applying the instruction braking force BPTr set in the degeneration processing to the vehicle 10 is also referred to as a “degeneration braking control”. When the instruction braking force BPTr becomes equal to the required braking force BPRq, the processing circuit 51 ends the braking control during stopping.

### <Functional Unit>

The processing circuit 51 functions as a remaining travel distance derivation unit M11, an increase processing unit M13, a reduction processing unit M15, an operation amount reduction determination unit M16, an instruction value reduction unit M17, an operation amount increase determination unit M18, an instruction value increase unit M19, a stopping determination unit M21, a degeneration processing unit M23, and a control unit M25 by the CPU 52 executing the control program in the memory 53. In the present embodiment, the remaining travel distance derivation unit M11 corresponds to a “stopping-related value acquisition unit” that acquires a stopping-related value. The stopping-related value is a parameter that decreases as the vehicle 10 approaches a predicted stopping position.

The remaining travel distance derivation unit M11 derives the remaining travel distance DIS during braking of the vehicle 10. That is, the remaining travel distance derivation unit M11 acquires the remaining travel distance DIS as the stopping-related value. For example, the remaining travel distance derivation unit M11 derives the remaining travel distance DIS based on a vehicle body speed VS of the vehicle 10 and the deceleration of the vehicle 10. The vehicle body speed VS is a moving speed of the vehicle 10 derived based on the wheel speed VW. The deceleration of the vehicle 10 is a deceleration correlated with the braking force BPAl applied to the vehicle 10. For example, the t deceleration of the vehicle 10 can be derived by differentiating the vehicle body speed VS with respect to time. The remaining travel distance derivation unit M11 predicts a position where the vehicle 10 stops based on the vehicle body speed VS and the deceleration of the vehicle 10. Then, the remaining travel distance derivation unit M11 derives a distance from the predicted stop position to a current position of the vehicle 10 as the remaining travel distance DIS.

The increase processing unit M13 executes the increase processing when both the remaining travel distance DIS being equal to or less than the first travel distance determination value DISth1 and the remaining travel distance DIS being longer than the second travel distance determination value DISth2 are satisfied.

Here, the braking control during stopping includes the increase correction control for applying the instruction braking force BPTr set by the increase processing to the vehicle 10 and the reduction correction control for applying the instruction braking force BPTr set by the reduction processing to the vehicle 10. Further, the reduction correction control is executed after the increase correction control is executed. When the reduction correction control is executed as described above, the deceleration of the vehicle 10 is significantly reduced. Therefore, the remaining travel distance DIS tends to be long.

Therefore, the increase processing unit M13 derives, as the offset value ΔBP, a value such that an actual stop distance becomes equal to a reference stop distance even when the reduction correction control is executed. The actual stop distance is a moving distance of the vehicle 10 from a reference time at which the remaining travel distance DIS becomes equal to the first travel distance determination value DISth1 until the vehicle 10 stops. The reference stop distance is a moving distance of the vehicle 10 from the reference time to the stop of the vehicle 10 when the vehicle 10 is stopped while the instruction braking force BPTr is maintained at the required braking force BPRq.

When the remaining travel distance DIS becomes equal to the first travel distance determination value DISth1, the increase processing unit M13 derives a value corresponding to the situation at that time as the offset value ΔBP. Then, the increase processing unit M13 derives the instruction braking force BPTr by adding the offset value ΔBP to the required braking force BPRq during the execution of the increase processing.

The operation amount X may be increased or the operation amount X may be reduced while the increase processing is being executed. In this case, the required braking force BPRq changes according to the fluctuation of the operation amount X. Therefore, even when the operation amount X is changed, the increase processing unit M13 continues the increase processing, so that the instruction braking force BPTr changes according to the fluctuation of the operation amount X. That is, the increase processing unit M13 derives the instruction braking force BPTr such that the difference between the instruction braking force BPTr and the required braking force BPRq (=BPTr−BPRq) is maintained even when the operation amount X changes during the execution of the increase processing.

The reduction processing unit M15 reduces the instruction braking force BPTr when both the remaining travel distance DIS being equal to or less than the second travel distance determination value DISth2 and the vehicle 10 being determined not stopped are satisfied. That is, the reduction processing unit M15 reduces the instruction braking force BPTr to the gradient corresponding braking force BPθ at a constant speed. A reduction speed of the instruction braking force BPTr at this time corresponds to a “predetermined reduction speed”. When the instruction braking force BPTr becomes equal to the gradient corresponding braking force BPθ, the reduction processing unit M15 holds the instruction braking force BPTr at the gradient corresponding braking force BPθ.

The operation amount reduction determination unit M16 determines whether the operation amount X is reducing while the reduction correction control is being executed. That is, the operation amount reduction determination unit M16 determines that the operation amount X is reducing in a situation in which the instruction braking force BPTr is smaller than the required braking force BPRq.

When the operation amount reduction determination unit M16 determines that the operation amount X is reducing, the instruction value reduction unit M17 reduces the instruction braking force BPTr a larger reduction speed of the predetermined reduction speed and the reduction speed of the required braking force BPRq. Specifically, the instruction value reduction unit M17 reduces and corrects the instruction braking force BPTr based on a larger reduction speed of the reduction speed of the instruction braking force BPTr derived by the reduction processing unit M15 and the reduction speed of the required braking force BPRq. For example, the instruction value reduction unit M17 corrects the instruction braking force BPTr derived by the reduction processing unit M15 such that the instruction braking force BPTr is reduced at the larger reduction speed of the two reduction speeds.

The operation amount increase determination unit M18 determines whether the operation amount X is increasing while the reduction correction control is being executed. That is, the operation amount increase determination unit M18 determines that the operation amount X is increasing in a situation in which the instruction braking force BPTr is smaller than the required braking force BPRq.

When the operation amount increase determination unit M18 determines that the operation amount X is increasing, the instruction value increase unit M19 increases the instruction braking force BPTr such that the difference between the instruction braking force BPTr and the required braking force BPRq (=BPTr−BPRq) decreases. Specifically, the instruction value increase unit M19 derives an operation increase amount ΔX that is an increase amount of the operation amount from an increase start time of the operation amount X. Then, the instruction value increase unit M19 increases and corrects the instruction braking force BPTr derived by the reduction processing unit M15 according to the operation increase amount ΔX. For example, the instruction value increase unit M19 derives an increase correction amount IBP such that the value increases as the operation increase amount ΔX increases. The instruction value increase unit M19 derives, as the instruction braking force BPTr, the sum of an increase reference braking force BPBI, which is the instruction braking force BPTr at the increase start time of the operation amount X, and the increase correction amount IBP.

When the remaining travel distance DIS becomes less than a determination remaining travel distance DISth3, the stopping determination unit M21 determines whether the vehicle 10 has stopped. As illustrated in FIGS. 2A to 2C, a distance shorter than the second travel distance determination value DISth2 is set as the determination remaining travel distance DISth3. The determination remaining travel distance DISth3 is a criterion for determining whether the vehicle 10 is about to stop. In the present embodiment, the stopping determination unit M21 counts the number of pulses CP included in the pulse signal output by the wheel speed sensor 103 from the time at which the remaining travel distance DIS becomes less than the determination remaining travel distance DISth3. The stopping determination unit M21 counts the number of pulses CP included in the pulse signal output by one wheel speed sensor 103 among the plurality of wheel speed sensors 103 mounted on the vehicle. When the number of pulses CP is equal to or greater than a determination number CPth, the stopping determination unit M21 determines that the vehicle 10 has stopped. Meanwhile, the stopping determination unit M21 determines that the vehicle 10 is not stopped when the number of pulses CP is less than the determination number CPth. That is, the determination number CPth is the number of pulses corresponding to the determination remaining travel distance DISth3.

The degeneration processing unit M23 executes the degeneration processing when it is determined that the vehicle 10 has stopped. The degeneration processing unit M23 increases the instruction braking force BPTr to the required braking force BPRq at a predetermined increase speed set in advance.

The control unit M25 controls the braking force BPAl applied to the vehicle 10 based on the instruction braking force BPTr. For example, the control unit M25 operates the braking device 30 based on the instruction braking force BPTr.

### <Braking Control During Stopping>

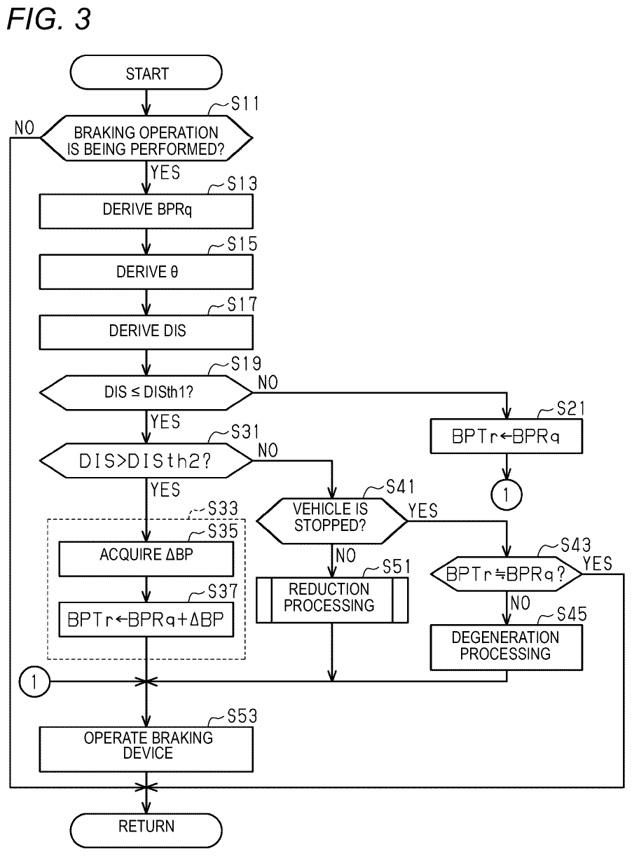

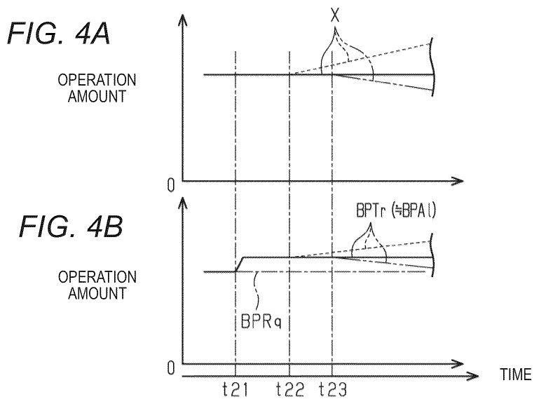

A flow of processing when the processing circuit 51 executes the braking control during stopping will be described with reference to FIGS. 3 to 4B. The processing circuit 51 repeatedly executes a series of processing illustrated in FIG. 3.

As illustrated in FIG. 3, in step S11, the processing circuit 51 determines whether a braking operation is being performed. The braking operation means that the driver operates the braking operation member 11. For example, the processing circuit 51 determines whether the braking operation is being performed based on the detection signal of the brake sensor 101. When determining that the braking operation is being performed (S11: YES), the processing circuit 51 shifts the processing to step S13. Meanwhile, when determining that the braking operation is not being performed (S11: NO), the processing circuit 51 temporarily ends the series of processing illustrated in FIG. 3.

In step S13, the processing circuit 51 derives the braking force corresponding to the operation amount X of the braking operation member 11 as the required braking force BPRq. For example, the processing circuit 51 derives, as the required braking force BPRq, a braking force that increases as the operation amount X increases. In subsequent step S15, the processing circuit 51 derives the road surface gradient θ that is the gradient of the traveling road of the vehicle 10. The processing circuit 51 derives a larger gradient as the road surface gradient e as the traveling road is in a steep gradient. For example, the processing circuit 51 derives, as the road surface gradient θ, a gradient that increases as the magnitude of the difference between the longitudinal acceleration Gx and the acceleration of the vehicle 10, which is a value obtained by differentiating the vehicle body speed VS with respect to time, increases.

In the next step S17, the processing circuit 51 functions as the remaining travel distance derivation unit M11 to derive the remaining travel distance DIS.

In subsequent step S19, the processing circuit 51 determines whether the remaining travel distance DIS is equal to or less than the first travel distance determination value DISth1. When the remaining travel distance DIS is equal to or less than the first travel distance determination value DISth1 (S19: YES), the processing circuit 51 shifts the processing to step S31. Meanwhile, when the remaining travel distance DIS is longer than the first travel distance determination value DISth1 (S19: NO), the processing circuit 51 shifts the processing to step S21.

In step S21, the processing circuit 51 functions as the control unit M25 to set the required braking force BPRq as the instruction braking force BPTr. Then, the processing circuit 51 shifts the processing to step S53.

In step S31, the processing circuit 51 determines whether the remaining travel distance DIS is longer than the second travel distance determination value DISth2. When the remaining travel distance DIS is longer than the second travel distance determination value DISth2 (S31: YES), the processing circuit 51 shifts the processing to step S33. Meanwhile, when the remaining travel distance DIS is equal to or less than the second travel distance determination value DISth2 (S31: NO), the processing circuit 51 shifts the processing to step S41.

In step S33, the processing circuit 51 functions as the increase processing unit M13 to execute the increase processing. Specifically, in step S35, the processing circuit 51 acquires the offset value ΔBP. In subsequent step S37, the processing circuit 51 sets the sum of the required braking force BPRq and the offset value ΔBP as the instruction braking force BPTr.

Here, a case in which the operation amount X of the braking operation member 11 is increased or the operation amount X is reduced while the processing circuit 51 is executing the increase correction control will be described with reference to FIGS. 4A and 4B. In FIGS. 4A and 4B, a case in which the operation amount X is held is indicated by a solid line. A case in which the operation amount X is increased in the middle is indicated by a broken line. A case in which the operation amount X is reduced in the middle is indicated by a two-dot chain line. A one-dot chain line in FIG. 4B indicates the transition of the required braking force BPRq when the operation amount X is held.

As illustrated in FIGS. 4A and 4B, when the processing circuit 51 starts the increase processing at a timing t21, a braking force larger than the required braking force BPRq is set as the instruction braking force BPTr. In a period in which the operation amount X is held, the processing circuit 51 holds the instruction braking force BPTr in order to hold the required braking force BPRq.

When the operation amount X is increased from a timing t22 as indicated by the broken line in FIG. 4A, the processing circuit 51 increases the required braking force BPRq according to the increase in the operation amount X. Accordingly, the instruction braking force BPTr, which is the sum of the required braking force BPRq and the offset value ΔBP, is increased as indicated by the broken line in FIG. 4B.

Meanwhile, when the operation amount X is reduced from a timing t23 as indicated by the two-dot chain line in FIG. 4A, the processing circuit 51 reduces the required braking force BPRq according to the reduction in the operation amount X. Accordingly, the instruction braking force BPTr is reduced as indicated by the two-dot chain line in FIG. 4B.

Returning to FIG. 3, after executing the increase processing in this manner, the processing circuit 51 shifts the processing to step S53.

In step S41, the processing circuit 51 functions as the stopping determination unit M21 to determine whether the vehicle 10 has stopped. When determining that the vehicle 10 has stopped (S41: YES), the processing circuit 51 shifts the processing to step S43. Meanwhile, when determining that the vehicle 10 is not stopped (S41: NO), the processing circuit 51 shifts the processing to step S51.

In step S43, the processing circuit 51 determines whether the instruction braking force BPTr is substantially equal to the required braking force BPRq. When determining that the instruction braking force BPTr is substantially equal to the required braking force BPRq (S43: YES), the processing circuit 51 temporarily ends the series of processing illustrated in FIG. 3. Meanwhile, when determining that the instruction braking force BPTr is smaller than the required braking force BPRq (S43: NO), the processing circuit 51 shifts the processing to step S45.

In step S45, the processing circuit 51 functions as the degeneration processing unit M23 to execute the degeneration processing. After setting the instruction braking force BPTr through the execution of the degeneration processing, the processing circuit 51 shifts the processing to step S53.

In step S51, the processing circuit 51 executes the reduction processing. The reduction processing will be described later. After setting the instruction braking force BPTr through the execution of the reduction processing, the processing circuit 51 shifts the processing to step S53.

In step S53, the processing circuit 51 functions as the control unit M25 to operate the braking device 30 based on the instruction braking force BPTr. The control for operating the braking device 30 according to the instruction braking force BPTr derived in step S37 is the increase correction control. The control for operating the braking device 30 according to the instruction braking force BPTr derived in step S51 is the reduction correction control. The control for operating the braking device 30 according to the instruction braking force BPTr derived in step S45 is the degeneration braking control. That is, the braking control during stopping includes the increase correction control, the reduction correction control, and the degeneration braking control. Thereafter, the processing circuit 51 temporarily ends the series of processing illustrated in FIG. 3.

### <Reduction Processing>

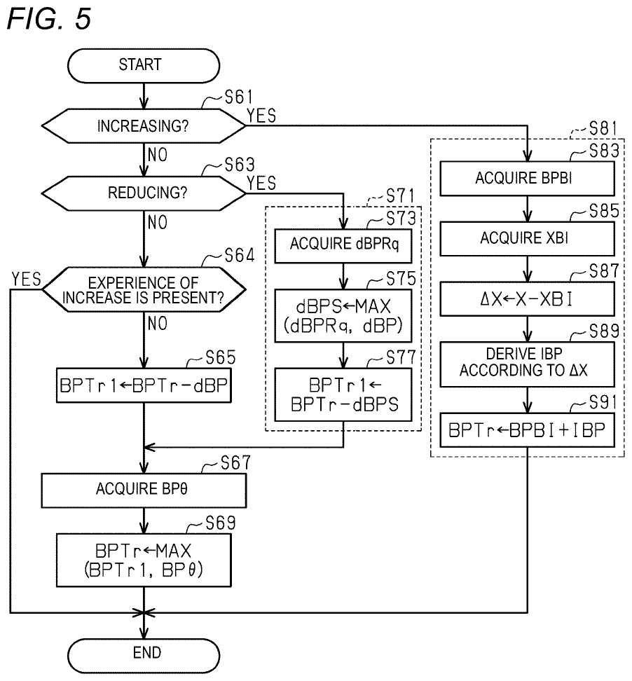

The reduction processing in step S51 will be described with reference to FIG. 5.

In step S61, the processing circuit 51 functions as the operation amount increase determination unit M18 to determine whether the operation amount X of the braking operation member 11 is increasing. When determining that the operation amount X is increasing (S61: YES), the processing circuit 51 shifts the processing to step S81. Meanwhile, when determining that the operation amount X is not increasing (S61: NO), the processing circuit 51 shifts the processing to step S63.

In step S63, the processing circuit 51 functions as the operation amount reduction determination unit M16 to determine whether the operation amount X is reducing. When determining that the operation amount X is reducing (S63: YES), the processing circuit 51 shifts the processing to step S71. Meanwhile, when determining that the operation amount X is not reducing (S63: NO), the processing circuit 51 shifts the processing to step S64.

In step S64, the processing circuit 51 determines whether there is an experience of an increase in the operation amount X while the reduction correction control is being executed during the current braking. If there is an experience of an increase in the operation amount X (S64: YES), the processing circuit 51 ends the reduction processing. In this case, the processing circuit 51 holds the instruction braking force BPTr. Meanwhile, if there is no experience of an increase in the operation amount X (S64: NO), the processing circuit 51 shifts the processing to step S65.

In step S65, the processing circuit 51 functions as the reduction processing unit M15 to derive a braking force obtained by subtracting a reference reduction amount dBP from the instruction braking force BPTr as a temporary value BPTr1 of a target braking force. Then, the processing circuit 51 shifts the processing to step S67.

In step S67, the processing circuit 51 functions as the instruction value reduction unit M17 to acquire the gradient corresponding braking force BPθ. The gradient corresponding braking force BPθ acquired by the processing circuit 51 is a braking force corresponding to the road surface gradient θ at the start time of the increase processing. The start time of the increase processing can be said to be the same as the start time of the braking control during stopping. Therefore, the gradient corresponding braking force BPθ can be said to be a braking force corresponding to the road surface gradient θ at a time when a start condition of the braking control during stopping is satisfied. When the gradient corresponding braking force BPθ is acquired, the processing circuit 51 shifts the processing to step S69.

In step S69, the processing circuit 51 functions as the reduction processing unit M15 to set a larger braking force of the temporary value BPTr1 of the target braking force and the gradient corresponding braking force BPθ as the instruction braking force BPTr. When the temporary value BPTr1 becomes equal to or less than the gradient corresponding braking force BPθ, the processing circuit 51 can hold the instruction braking force BPTr at the gradient corresponding braking force BPθ. Thereafter, the processing circuit 51 ends the reduction processing.

In step S71, the processing circuit 51 functions as the instruction value reduction unit M17 to reduce the instruction braking force BPTr. Specifically, in step S73, the processing circuit 51 acquires a reduction amount dBPRq of the required braking force BPRq as the reduction speed of the required braking force BPRq. The reduction amount dBPRq is a reduction amount of the required braking force BPRq per unit time. The unit time is equal to the length of the execution cycle of the reduction processing. For example, the processing circuit 51 may derive the difference between a previous value and a latest value of the required braking force BPRq as the reduction amount dBPRq. In subsequent step S75, the processing circuit 51 acquires a larger reduction amount of the reduction amount dBPRq of the required braking force and the reference reduction amount dBP as a selected reduction amount dBPS. Then, in step S77, the processing circuit 51 derives a braking force obtained by subtracting the selected reduction amount dBPS from the instruction braking force BPTr as the temporary value BPTr1 of the target braking force. Thereafter, the processing circuit 51 sequentially executes the processing of step S67 and the processing of step S69, and then ends the reduction processing.

In step S81, the processing circuit 51 functions as the instruction value increase unit M19 to increase the instruction braking force BPTr. Specifically, in step S83, the processing circuit 51 acquires, as the increase reference braking force BPBI, the instruction braking force BPTr at the time when it is determined that the operation amount X is increasing. In subsequent step S85, the processing circuit 51 acquires, as an increase reference operation amount XBI, the operation amount X at the time when it is determined that the operation amount X is increasing. In the next step S87, the processing circuit 51 derives a value obtained by subtracting the increase reference operation amount XBI from the current operation amount X as the operation increase amount ΔX. In subsequent step S89, the processing circuit 51 derives an increase correction amount IBP corresponding to the operation increase amount ΔX. For example, the processing circuit 51 derives, as the increase correction amount IBP, a value that increases as the operation increase amount ΔX increases. Then, in step S91, the processing circuit 51 derives the sum of the increase reference braking force BPBI and the increase correction amount IBP as the temporary value BPTr1 of the target braking force. Accordingly, the processing circuit 51 can increase the instruction braking force BPTr such that the difference between the instruction braking force BPTr and the required braking force BPRq (=BPTr−BPRq) decreases. Thereafter, the processing circuit 51 sequentially executes the processing of step S67 and the processing of step S69, and then ends the reduction processing.

### <Operations and Effects of Present Embodiment>

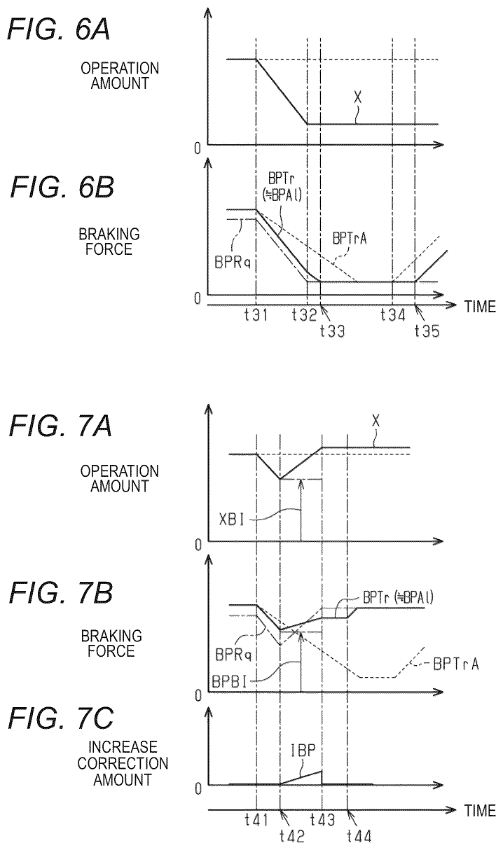

The operations and effects of the braking control device 50 when the driver is operating the braking operation member 11 will be described with reference to FIGS. 6A to 7C. The example illustrated in FIGS. 6A and 6B are a case in which the operation amount X is reduced while the reduction correction control is being executed. The example illustrated in FIGS. 7A to 7C are a case in which the operation amount X is reduced and then the operation amount X is increased while the reduction correction control is being executed.

### <Case in Which Operation Amount is Reduced While Reduction Correction Control is Being Executed>

An instruction braking force BPTrA indicated by a broken line in FIG. 6B is the instruction braking force BPTr when the operation amount X is held as indicated by a broken line in FIG. 6A. A one-dot chain line in FIG. 6B indicates a transition of the required braking force BPRq when the operation amount X transitions as indicated by a solid line in FIG. 6A.

In the example illustrated in FIGS. 6A and 6B, the processing circuit 51 starts the reduction correction control from a timing t31. Further, as illustrated in FIG. 6A, the required braking force BPRq starts to be reduced due to the reduction of the operation amount X from the timing t31. The reduction speed of the required braking force BPRq indicated by the one-dot chain line in FIG. 6B corresponds to the reduction amount dBPRq of the required braking force. The reduction speed of the instruction braking force BPTrA indicated by the broken line in FIG. 6B corresponds to the reference reduction amount dBP. In the period from the timing t31 to a timing t32, the reduction speed of the required braking force BPRq is larger than the reduction speed of the instruction braking force BPTrA. Therefore, the processing circuit 51 reduces the instruction braking force BPTr based on the reduction amount dBPRq of the required braking force. Accordingly, when the operation amount X is reducing even while the reduction processing is being executed, the braking control device 50 can reduce the braking force BPAl at a speed corresponding to the demand of the driver.

When the operation amount X is reduced before the vehicle 10 stops, it is considered that the driver operates the braking operation member 11 in order to prevent a sudden change in the vehicle attitude during the stopping of the vehicle. However, when the reduction speed of the operation amount X at that time is small, the reduction speed of the required braking force BPRq does not increase so much. In such a state, a sudden change in the vehicle attitude during the stopping of the vehicle can be more suitably prevented in a case in which the instruction braking force BPTr is reduced based on the reference reduction amount dBP than in a case in which the instruction braking force BPTr is reduced at a speed corresponding to the reduction speed of the required braking force BPRq.

When both the required braking force BPRq and the instruction braking force BPTrA are reduced, the reduction speed of the instruction braking force BPTrA may become larger than the reduction speed of the required braking force BPRq. In this case, the processing circuit 51 reduces the instruction braking force BPTr based on the reference reduction amount dBP. That is, by executing the reduction correction control, the braking control device 50 can prevent a sudden change in the vehicle attitude during the stopping of the vehicle even when the braking operation member 11 is operated by the driver.

In the example illustrated in FIGS. 6A and 6B, the operation amount X is held after the timing t32, but the instruction braking force BPTr is larger than the gradient corresponding braking force BPθ at the timing t32. Therefore, in the period from the timing t32 to a timing t33, the processing circuit 51 reduces the instruction braking force BPTr based on the reference reduction amount dBP. Then, from the timing t33, the processing circuit 51 holds the instruction braking force BPTr at the gradient corresponding braking force BPθ.

A timing t34 illustrated in FIGS. 6A and 6B is a timing at which it is determined that the vehicle 10 has stopped when the required braking force BPRq is not reduced. However, in the example illustrated in FIGS. 6A and 6B, the operation amount X is reduced during braking of the vehicle 10. Therefore, at a timing t35 after the timing t34, the processing circuit 51 determines that the vehicle 10 has stopped. Therefore, the processing circuit 51 increases the braking force BPAl toward the required braking force BPRq by starting the degeneration braking control from the timing t35.

### <Case in Which Operation Amount is Increased While Reduction Correction Control is Being Executed>

The instruction braking force BPTrA indicated by a broken line in FIG. 7B is the instruction braking force BPTr when the operation amount X is held as indicated by a broken line in FIG. 7A. A one-dot chain line in FIG. 7B indicates a transition of the required braking force BPRq when the operation amount X transitions as indicated by a solid line in FIG. 7A.

In the example illustrated in FIGS. 7A to 7C, the processing circuit 51 starts the reduction correction control from a timing t41. Further, as illustrated in FIG. 7A, the required braking force BPRq starts to be reduced due to the reduction of the operation amount X from the timing t41. In the period from the timing t41 to a timing t42, the reduction speed of the required braking force BPRq is larger than the reduction speed of the instruction braking force BPTrA. Therefore, the processing circuit 51 reduces the instruction braking force BPTr based on the reduction amount dBPRq of the required braking force. Accordingly, when the operation amount X is reduced even while the reduction correction control is being executed, the braking control device 50 can reduce the braking force BPAl at a speed corresponding to the demand of the driver.

In the example illustrated in FIGS. 7A to 7C, the operation amount X is increased from the timing t42 to a timing t43. Therefore, the processing circuit 51 stores the instruction braking force BPTr at the timing t42 as the increase reference braking force BPBI, and stores the operation amount X at the timing t42 as the increase reference operation amount XBI.

In the period from the timing t42 to the timing t43, the processing circuit 51 derives the operation increase amount ΔX by subtracting the increase reference operation amount XBI from the current operation amount X. Then, as illustrated in FIG. 7C, the processing circuit 51 derives, as the increase correction amount IBP, a value that increases as the operation increase amount ΔX increases. In this period, the instruction braking force BPTr is larger than the gradient corresponding braking force BPθ. Therefore, the processing circuit 51 derives, as the instruction braking force BPTr, the sum of the increase correction amount IBP based on the operation increase amount ΔX and the previous value of the instruction braking force BPTr.

The operation increase amount ΔX corresponds to a demand value of the increase amount of the braking force BPAl from the timing t42. In the braking control device 50, the processing circuit 51 derives a value corresponding to the operation increase amount ΔX as the increase correction amount IBP. That is, the processing circuit 51 increases the instruction braking force BPTr according to the operation increase amount ΔX. Thus, when the operation amount X is increased while the reduction correction control is being executed, the braking control device 50 can cause the vehicle 10 to generate a deceleration according to the intention of the driver. That is, when the driver increases the operation amount X, the braking control device 50 can prevent the deceleration of the vehicle 10 from becoming excessively large with respect to the increase amount of the operation amount X.

In the example illustrated in FIGS. 7A to 7C, when determining that the vehicle 10 has stopped at a timing t44, the processing circuit 51 starts the degeneration braking control.

In the prevent embodiment, the following effects can be further obtained.
(1) The processing circuit 51 acquires, as the gradient corresponding braking force BPθ, the braking force corresponding to the road surface gradient θ at the time when the remaining travel distance DIS becomes equal to or less than the first travel distance determination value DISth1 and the increase correction control is started. However, if the vehicle 10 continues to travel thereafter, there is a possibility that the gradient of the traveling road is larger than the road surface gradient θ at the start time of the increase correction control. In this case, when the braking force BPAl is reduced to the gradient corresponding braking force BPθ while the reduction correction control is being executed, the vehicle 10 may stop after passing the predicted stop position.

In this regard, in the braking control device 50, the processing circuit 51 starts the degeneration braking control when the number of pulses CP included in the pulse signal output by the wheel speed sensor 103 from the time when the remaining travel distance DIS becomes less than the determination remaining travel distance DISth3 becomes equal to or greater than the determination number CPth in a situation in which the braking force BPAl is less than the required braking force BPRq. Then, the processing circuit 51 increases the braking force BPAl by increasing the instruction braking force BPTr by the degeneration processing. As a result, even when the gradient of the traveling road increases after the increase correction control is started, the braking control device 50 can cause the vehicle 10 to stop near the predicted stop position.
(2) In the degeneration processing, the processing circuit 51 increases the instruction braking force BPTr to the required braking force BPRq. As a result, after the end of the degeneration processing, the braking force BPAl becomes substantially equal to the required braking force BPRq. Accordingly, the braking control device 50 can prevent the vehicle 10 from being stopped in a state in which the braking force BPAl deviates from the required braking force BPRq even when the reduction correction control is executed.

### Second Embodiment

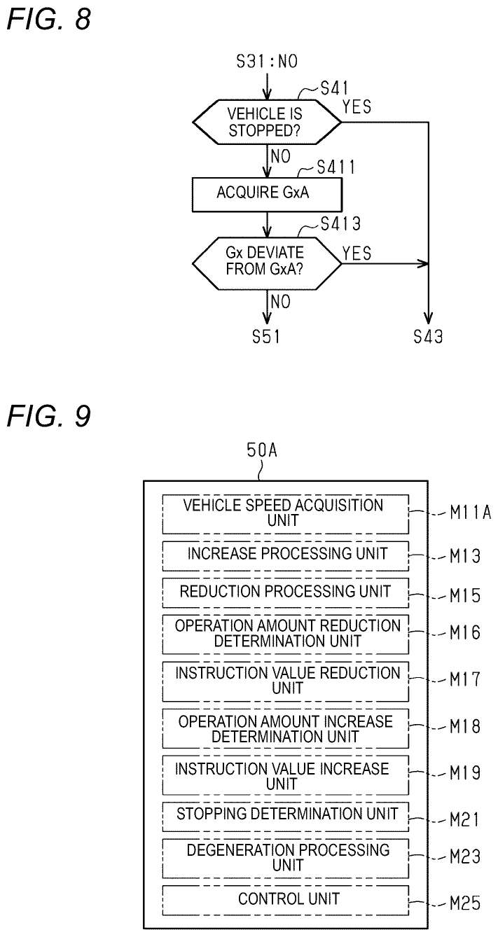

A second embodiment of the braking control device will be described with reference to FIG. 8. The second embodiment is different from the first embodiment in that the start timing of the degeneration processing is determined using the longitudinal acceleration Gx. In the following description, portions different from those of the first embodiment are mainly described. The same members as those of the first embodiment are denoted by the same reference signs, and a repeated description thereof is omitted.

### <Degeneration Processing Unit>

Processing contents of the degeneration processing unit M23 of the present embodiment will be described.

When the braking device 30 is operated based on the instruction braking force BPTr set by the reduction processing unit M15, the degeneration processing unit M23 acquires the longitudinal acceleration Gx corresponding to a detection signal of the longitudinal acceleration sensor 102. The longitudinal acceleration Gx corresponds to an “output value” corresponding to the detection signal of the longitudinal acceleration sensor 102. The degeneration processing unit M23 determines whether the longitudinal acceleration Gx deviates from an ideal longitudinal acceleration GxA. For example, the degeneration processing unit M23 determines that the longitudinal acceleration Gx deviates from the ideal longitudinal acceleration GxA when the magnitude of the difference between the longitudinal acceleration Gx and the ideal longitudinal acceleration GxA is equal to or greater than a deviation determination value. In this case, the degeneration processing unit M23 determines that the longitudinal acceleration Gx does not deviate from the ideal longitudinal acceleration GxA when the magnitude of the difference between the longitudinal acceleration Gx and the ideal longitudinal acceleration GxA is less than the deviation determination value.

The ideal longitudinal acceleration GxA is a longitudinal acceleration corresponding to the instruction braking force BPTr. Specifically, the sum of a gravitational acceleration corresponding to the road surface gradient e at a start time of increase processing and a longitudinal acceleration corresponding to the current instruction braking force BPTr or an acceleration close to the sum is set as the ideal longitudinal acceleration GxA.

Therefore, when a gradient of a traveling road greatly changes from the start time of the increase processing, the longitudinal acceleration Gx deviates from the ideal longitudinal acceleration GxA. Then, when the gradient of the traveling road greatly changes from a start time of reduction processing, it is desirable to early start the degeneration processing to early increase the braking force BPAl. Therefore, when determining that the longitudinal acceleration Gx deviates from the ideal longitudinal acceleration GxA, the degeneration processing unit M23 starts the degeneration processing even if it is determined that the vehicle 10 is not stopped.

### <Braking Control During Stopping>

With reference to FIG. 8, a flow of processing when the processing circuit 51 executes braking control during stopping will be described focusing on differences from the first embodiment.

When the remaining travel distance DIS is equal to or less than the second travel distance determination value DISth2 (S31: NO), the processing circuit 51 shifts the processing to step S41.

In step S41, the processing circuit 51 functions as the stopping determination unit M21 to determine whether the vehicle 10 has stopped. When determining that the vehicle 10 has stopped (S41: YES), the processing circuit 51 shifts the processing to step S43. Meanwhile, when determining that the vehicle 10 is not stopped (S41: NO), the processing circuit 51 shifts the processing to step S411.

In step S411, the processing circuit 51 functions as the degeneration processing unit M23 to acquire the ideal longitudinal acceleration GxA. In the next step S413, the processing circuit 51 functions as the degeneration processing unit M23 to determine whether the longitudinal acceleration Gx deviates from the ideal longitudinal acceleration GxA. When determining that the longitudinal acceleration Gx deviates from the ideal longitudinal acceleration GxA (S413: YES), the processing circuit 51 shifts the processing to step S43 illustrated in FIG. 3. Meanwhile, when determining that the longitudinal acceleration Gx does not deviate from the ideal longitudinal acceleration GxA (S413: NO), the processing circuit 51 shifts the processing to step S51 illustrated in FIG. 3. In this case, the processing circuit 51 functions as the reduction processing unit M15 to execute the reduction processing.

### <Operations and Effects of Present Embodiment>

When the reduction processing is executed, the braking force BPAl is smaller than the required braking force BPRq. In such a situation, the processing circuit 51 determines whether the longitudinal acceleration Gx deviates from the ideal longitudinal acceleration GxA. When the longitudinal acceleration Gx deviates from the ideal longitudinal acceleration GxA, there is a possibility that the gradient of the traveling road has changed from the start time of the increase processing. In this case, there is a possibility that the stop of the vehicle 10 cannot be maintained even if the braking force BPAl is maintained at the gradient corresponding braking force BPθ by executing the reduction processing. That is, even if the degeneration processing is executed after it is determined that the vehicle 10 has stopped, the vehicle 10 may move slightly because the increase in the braking force BPAl is delayed.

In this regard, in the braking control device 50, when determining that the longitudinal acceleration Gx deviates from the ideal longitudinal acceleration GxA, the processing circuit 51 starts the degeneration processing before it is determined that the vehicle 10 has stopped. Accordingly, the increase of the braking force BPAl is prevented from being delayed. As a result, even if the road surface gradient θ increases after the increase processing is started, the braking control device 50 can maintain the state in which the vehicle 10 is stopped.

### <Modifications>

The plurality of embodiments described above can be modified as follows. The plurality of embodiments described above and the following modifications can be implemented in combination with each other within a technically consistent range.

The processing circuit 51 may not make the instruction braking force BPTr equal to the required braking force BPRq as long as the instruction braking force BPTr is increased in the degeneration processing. That is, the processing circuit 51 may set a specified braking force having a magnitude different from that of the required braking force BPRq and increase the instruction braking force BPTr to the specified braking force.

When the operation amount X is reduced while the reduction correction control is being executed, the processing circuit 51 may derive a value between the reduction amount dBPRq of the required braking force and the reference reduction amount dBP as the selected reduction amount dBPS.

The processing circuit 51 may reduce the instruction braking force BPTr based on the reference reduction amount dBP even when the operation amount X is reduced while the reduction correction control is being executed.

In the second embodiment, the processing circuit 51 may determine whether the vehicle 10 has stopped using the vehicle body speed VS.

The braking control during stopping may be a control not including the increase correction control.

The vehicle 10 may include a vertical acceleration sensor that detects a vertical acceleration of the vehicle 10. In the braking control device applied to the vehicle 10, the processing circuit 51 may determine whether the road surface gradient has changed using an output value corresponding to a detection signal of the vertical acceleration sensor. In this case, the vertical acceleration sensor corresponds to the “gradient detection sensor”.

The processing circuit 51 functions as the degeneration processing unit M23 to acquire the vertical acceleration, which is an output value corresponding to the detection signal of the vertical acceleration sensor, as a reference vertical acceleration before the start time of the reduction correction control. The reference vertical acceleration corresponds to a “reference output value”. For example, the processing circuit 51 acquires the vertical acceleration at the start time of the increase correction control as the reference vertical acceleration.

When determining that the vertical acceleration deviates from the reference vertical acceleration while the reduction correction control is being executed, the processing circuit 51 can determine that the road surface gradient has changed, and thus increases the instruction braking force BPTr by the degeneration processing. Accordingly, the braking control device can obtain the same effects as those of the second embodiment.

Instead of the remaining travel distance DIS, the processing circuit 51 may acquire a vehicle speed SP, which is the vehicle body speed VS of the vehicle 10, as the stopping-related value. That is, as illustrated in FIG. 9, in a braking control device 50A, the processing circuit 51 may function as a vehicle speed acquisition unit M11A. In this case, the vehicle speed acquisition unit M11A functions as the “stopping-related value acquisition unit”. According to this, when the vehicle speed SP becomes less than a first stopping vehicle speed determination value, the processing circuit 51 functions as the increase processing unit M13 to start the increase processing. In addition, the processing circuit 51 starts the reduction processing when the vehicle speed SP becomes equal to or less than a second stopping vehicle speed determination value.

The processing circuit 51 functions as the stopping determination unit M21 to determine whether the vehicle 10 has stopped when the vehicle speed SP becomes less than a determination vehicle speed SPth. A vehicle speed lower than the second stopping vehicle speed determination value is set as the determination vehicle speed SPth. The determination vehicle speed SPth corresponds to the “determination stopping-related value”. The processing circuit 51 measures the number of pulses CP included in the pulse signal output by the wheel speed sensor 103 from the time when the vehicle speed SP becomes less than the determination vehicle speed SPth. Then, the processing circuit 51 determines that the vehicle 10 has stopped when the number of pulses CP becomes equal to or greater than the determination number CPth.

The braking control device may control not only a friction braking force but also a regenerative braking force when the braking control during stopping is executed. In this case, the sum of the total of the friction braking forces applied to the vehicle 10 and the total of the regenerative braking forces applied to the vehicle 10 is the braking force BPAl.

The processing circuit 51 may be implemented as a circuit including one or more processors that operate in accordance with a computer program, one or more dedicated hardware circuits such as dedicated hardware that performs some processing of various types of processing, or a combination thereof. Examples of dedicated hardware include an application-specific integrated circuit (ASIC). The processor includes a CPU and a memory such as a RAM and a ROM. The memory stores a program code or a command configured to cause the CPU to execute processing. The memory, that is, a storage medium includes any available medium that can be accessed by a general-purpose or dedicated computer.

### <Other Technical Ideas>

Technical ideas that can be grasped from the plurality of embodiments and the modifications will be described below.
(Supplementary Note 1) It is preferable that the reduction correction control is a control including gradually reducing the instruction braking force to a gradient corresponding braking force that is a braking force corresponding to a road surface gradient before the reduction correction control is started, and holding the instruction braking force when the instruction braking force reaches the gradient corresponding braking force.
(Supplementary Note 2) It is preferable that the degeneration processing unit increases the instruction braking force to the required braking force.

The expression “at least one” used in the present specification means “one or more” desired options. As an example, the expression “at least one” used in the present specification means “only one option” or “both of two options” when the number of options is two. As another example, the expression “at least one” used in the present specification means “only one option” or “any combination of two or more options” when the number of options is three or more.

1. A braking control device for executing, when a driver of a vehicle is operating a braking operation member of the vehicle to stop the vehicle while the vehicle is traveling, a reduction correction control for applying, to the vehicle, an instruction braking force smaller than a required braking force that is a braking force corresponding to an operation amount of the braking operation member by the driver, in order to prevent an attitude change of the vehicle accompanying the stopping, the braking control device comprising:
an operation amount increase determination unit configured to determine whether the operation amount is increasing while the reduction correction control is being executed; and
an instruction value increase unit configured to, when the operation amount increase determination unit determines that the operation amount is increasing, increase the instruction braking force such that a difference between the instruction braking force and the required braking force decreases.

2. The braking control device according to claim 1, further comprising:
an operation amount reduction determination unit configured to determine whether the operation amount is reducing while the reduction correction control is being executed; and
an instruction value reduction unit configured to, when the operation amount reduction determination unit determines that the operation amount is reducing, reduce the instruction braking force at a larger reduction speed of a predetermined reduction speed and a reduction speed of the required braking force.

3. The braking control device according to claim 2, which is applied to a vehicle including a wheel speed sensor configured to output a pulse signal according to a rotation speed of a wheel, the braking control device further comprising:
a stopping-related value acquisition unit configured to acquire, as a stopping-related value, a distance over which the vehicle travels until the vehicle stops or a vehicle speed until the vehicle stops; and
a degeneration processing unit configured to increase the instruction braking force when, under a situation in which the braking force is less than the required braking force, the number of pulses included in the pulse signal output by the wheel speed sensor from a time at which the stopping-related value becomes less than a determination stopping-related value becomes equal to or greater than a determination number that is the number of pulses according to the determination stopping-related value.

4. The braking control device according to claim 2, which is applied to a vehicle including a gradient detection sensor configured to detect a road surface gradient that is a gradient of a traveling road of the vehicle, the braking control device further comprising
a degeneration processing unit configured to increase the instruction braking force when an output value corresponding to a detection signal of the gradient detection sensor is determined to deviate from a reference output value that is an output value corresponding to a detection signal of the gradient detection sensor before the reduction correction control is started.

5. The braking control device according to claim 1, which is applied to a vehicle including a wheel speed sensor configured to output a pulse signal according to a rotation speed of a wheel, the braking control device further comprising:
a stopping-related value acquisition unit configured to acquire, as a stopping-related value, a distance over which the vehicle travels until the vehicle stops or a vehicle speed until the vehicle stops; and
a degeneration processing unit configured to increase the instruction braking force when, under a situation in which the braking force is less than the required braking force, the number of pulses included in the pulse signal output by the wheel speed sensor from a time at which the stopping-related value becomes less than a determination stopping-related value becomes equal to or greater than a determination number that is the number of pulses according to the determination stopping-related value.

6. The braking control device according to claim 1, which is applied to a vehicle including a gradient detection sensor configured to detect a road surface gradient that is a gradient of a traveling road of the vehicle, the braking control device further comprising
a degeneration processing unit configured to increase the instruction braking force when an output value corresponding to a detection signal of the gradient detection sensor is determined to deviate from a reference output value that is an output value corresponding to a detection signal of the gradient detection sensor before the reduction correction control is started.
